(19) United States
(12) Patent Application Publication
(10) Pub. No.: US 2024/0020630 A1
(43) Pub. Date: Jan. 18, 2024

(54) SYSTEMS AND METHODS FOR MACHINE LEARNING-BASED IDENTIFICATION OF DYNAMIC RESOURCE REORDERING POINTS

(71) Applicant: JPMORGAN CHASE BANK, N.A., New York, NY (US)

(72) Inventors: Christian Howard Post, Houston, TX (US); Allen Siemens, Houston, TX (US); Rebekah Koehn, Houston, TX (US); Gregorio Antonino, Antonino (AR); Zhaofeng Liang, Houston, TX (US); Arpana Erukala, Hyderabad (IN); Pilar Garcia, Florencio Varela (AR)

(21) Appl. No.: 17/929,276

(22) Filed: Sep. 1, 2022

(30) Foreign Application Priority Data
Jul. 15, 2022 (IN) 202211040655

(51) Int. Cl. G06Q 10/08; G06Q 10/06; G06Q 30/02

(52) U.S. Cl. CPC G06Q 10/087; G06Q 10/06315; G06Q 30/0202

(57) ABSTRACT

Systems and methods for machine learning-based identification of dynamic resource reordering points are disclosed. In one embodiment, a method may include a resource management computer program executed on an electronic device: (1) receiving historical resource availability data, historical resource consumption data, and historical resource reordering data for a resource; (2) training a machine learning engine to predict dynamic resource reordering points for the resource using the historical resource availability data, the historical resource consumption data, and the historical resource reordering data; (3) receiving current resource availability data, current resource demand data, and current resource reordering data for the resource; (4) predicting a dynamic resource reordering point for the resource based on the current resource availability data, the current resource demand data, and/or the current resource reordering data; and (5) requesting additional resources in response to threshold for the dynamic resource reordering point being met.

### RELATED APPLICATIONS

This application claims priority to, and the benefit of, Indian Patent Application No. 202211040655 filed Jul. 15, 2022, the disclosure of which is hereby incorporated, by reference, in its entirety.

### BACKGROUND OF THE INVENTION

### 1. Field Of The Invention

Embodiments generally relate to systems and methods for machine learning-based identification of dynamic resource reordering points.

### 2. Description of the Related Art

In an environment where customer needs and supply lead times are constantly changing, many business hours are spent analyzing when to purchase more inventory and how much inventory to purchase. Often by the time a calculation is complete, and a decision is made, the data used to arrive at that ordering decision is already obsolete. This makes optimizing inventory levels and customer experience a challenge. Decisions are made to either hold inventory, driving up costs and environmental impact (e.g., carbon emissions, kW of power, etc.), or to sacrifice customer experience (e.g., slower deliveries) to lower costs. In these forecasted-push environments, delivery lead times are very long due to a high number of manual steps, approvals, and handoffs.

### SUMMARY OF THE INVENTION

Systems and methods for machine learning-based identification of dynamic resource reordering points are disclosed. In one embodiment, a method for machine learning-based identification of dynamic resource reordering points, may include: (1) receiving, by a resource management computer program executed on an electronic device, historical resource availability data, historical resource consumption data, and historical resource reordering data for a resource; (2) training, by the resource management computer program, a machine learning engine to predict dynamic resource reordering points for the resource using the historical resource availability data, the historical resource consumption data, and the historical resource reordering data; (3) receiving, by the resource management computer program, current resource availability data, current resource demand data, and current resource reordering data for the resource; (4) predicting, by the resource management computer program and using the machine learning engine, a dynamic resource reordering point for the resource based on the current resource availability data, the current resource demand data, and/or the current resource reordering data; and (5) requesting, by the resource management computer program, additional resources in response to threshold for the dynamic resource reordering point being met.

In one embodiment, the resource may be a physical good or a service.

In one embodiment, the resource may be a computer resource and the current resource availability data may be received from the computer resource.

In one embodiment, the resource may be a human resource.

In one embodiment, the resource management computer program may train a plurality of machine learning engines using different timescales and may select the machine learning engine that is most constraining.

In one embodiment, the method may also include receiving, by the resource management computer program, external data, wherein the external data impacts supply or demand for the resource.

In one embodiment, the method may also include receiving, by the resource management computer program, supply-related data for the resource.

In one embodiment, the current resource availability data may be received as telemetry of machinery.

In one embodiment, the resource management computer program may train the machine learning engine using supervised learning or may train a neural network.

In one embodiment, the method may also include monitoring, by the resource management computer program, the current resource availability data, current resource demand data, and current resource reordering data for a change that changes the dynamic resource reordering point; and predicting, by the resource management computer program and using the machine learning engine, an updated dynamic resource reordering point for the resource based on the current resource availability data, the current resource demand data, and/or the current resource reordering data.

In one embodiment, the dynamic resource reordering point may include a data, a time of day, a minimum availability threshold, a demand velocity, and/or occurrence of a demand event.

According to another embodiment, a method for machine learning-based identification of dynamic resource reordering points may include: (1) receiving, by a resource management computer program executed by an electronic device, a goal for a customer service level for a resource; (2) receiving, by the resource management computer program, current resource availability data for the resource; (3) determining, by the resource management computer program, a current customer service level for the resource; (4) comparing, by the resource management computer program, the current customer service level to the goal for a customer service level; (5) executing, by the resource management computer program, and action in response to the comparison; (6) monitoring, by the resource management computer program, an impact of the execution; and (7) retraining, by the resource management computer program, a trained dynamic resource reordering point machine learning engine based on the monitoring.

In one embodiment, the resource may be a physical good or a service, a computer resource, a human resource, etc.

In one embodiment, the goal for the customer service level and the current customer service level may be based on a time to make the resource available.

In one embodiment, the action may include raising a dynamic resource reordering point in response to the current customer service level being below the goal for the customer service level.

In one embodiment, the action may include lowering a dynamic resource reordering point in response to the current customer service level being above the goal for the customer service level.

In one embodiment, the resource management computer program may retrain the trained machine learning engine using supervised learning or may retrain a neural network.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for machine learning-based identification of dynamic resource reordering points according to an embodiment;

FIG. 2 depicts a method for machine learning-based identification of dynamic resource reordering points according to an embodiment;

FIG. 3 depicts a method for machine learning-based identification of dynamic resource reordering points according to another embodiment; and

FIG. 4 depicts a method for determining an optimal reordering point using simulation according to an embodiment.

### DETAILED DESCRIPTION OF PREFERRED EMBODIMENTS

Embodiments are directed to systems and methods for machine learning-based identification of dynamic resource reordering points.

Embodiments may apply automated, dynamic reorder points in order to optimize inventory of any resource (e.g., physical resources, human resources, virtual resources, etc.). There can be a single reorder point at one stage of a value stream, or a network of reorder points operating in series across many stages of the value stream. Embodiments may be customizable for a desired customer service level, thereby providing the lowest cost structure to achieve the desired customer experience.

Embodiments may provide sequential reordering points that shorten lead times by enabling full time monitoring and execution against these reorder points. Calculations use the latest telemetry from a plurality of systems, resulting in having the required amount of supply in the right place just in time for consumers of the resources, such as humans, legal entities (e.g., business entities), machines, computer programs, etc.

In one embodiment, the reordering point may be selected to achieve a certain customer service level, to achieve a certain cost of maintaining inventory, or a combination of both.

The demand for resources can be positive or negative. For example, positive demand means consumers are consuming more resources thereby driving inventory down, while negative demand means that resources are being returned, thereby driving inventory up. By having two different type of demands that are drive inventory in either direction, it is important for us to keep a close eye on how the demand affects the inventory and the dynamic reorder point(s).

Embodiments may provide at least some of the following technical advantages: (1) embodiments may automatically calculate reorder point(s) for resources based on, for example, current inventory, demand, ordering velocity, etc.; (2) embodiments may automatically order additional resources based on the reorder points; (3) embodiments may dynamically update reorder points; (4) embodiments may provide a configurable and trainable customer service level based on needs; (5) embodiments may generate specific data payloads for automated execution systems; (6) embodiments may monitor the impact of decisions and may use the results to retrain machine learning engines.

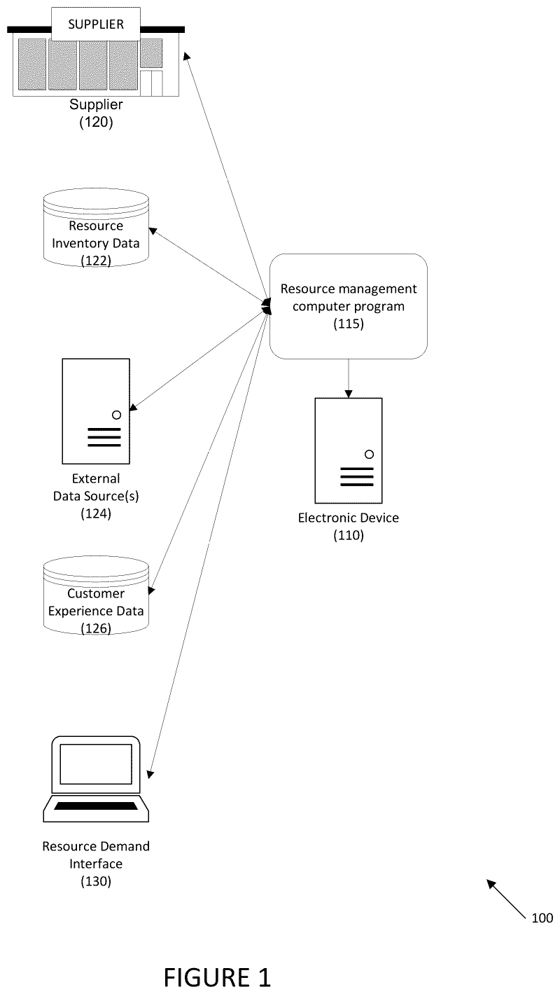

Referring to FIG. 1, a system for machine learning-based identification of dynamic resource reordering points is provided according to an embodiment. System 100 may include electronic device 110, which may be a server (e.g., physical and/or cloud-based), a computer (e.g., workstation, desktop, laptop, tablet, etc.), etc. Electronic device 110 may execute resource management computer program 115, which may calculate one or more reordering points for an inventory of a resource.

As used herein, the term “resource” may refer to any tangible or intangible good or service that may have a controlled inventory. Examples may include physical resources (e.g., widgets, sub-widgets used to complete widgets, etc.), human resources (e.g., workers), computer resources (e.g., memory, central processing unit (CPU) cycles, virtual machines, cloud-based resources, etc.), time resources, data resources (e.g., value, fields), business process resources (e.g., pre-approvals, tickets, requests, responses), etc.

System 100 may include a supplier 120, which may be a supplier of a resource. Supplier 120 may provide physical resources, human resources, computing resources, virtual resources, logical resources, data resources, business process resources, etc.

System 100 may further include one or more data source for resource information, such as resource inventory data 122, external data source(s) 124, and customer experience data 126. Resource inventory data 122 may further include, for example, an amount of a resource in inventory, a timing of resupply, historical demand data, etc.

External data source(s) 124 may represent repeat patterns and/or infrequent events. External data source(s) 124 may provide external data such as weather data, local and global environmental data, supply-related data such as the telemetry of machinery and systems, timing within a lifecycle or lifecycle-to-lifecycle transition, availability of labor, availability of transportation to provide the resource, the impact on border customs, the availability of raw material, geopolitical data, market data, availability or speed of computer-to-computer information flow (e.g., network traffic), a computational capacity, a connection capacity and/or data capacity, etc. External data and/or supply-related data may include discrete data points and/or the comparison of any number of analytical tools or models of discrete data, such as linear regression, moving averages, exponential smoothing, Holtz-Winters, etc.

Customer experience data 126 may include one or more values that represent customer expectations (e.g., a percentage of requests fulfilled immediately), a pace of customer consumption, a type of customer consumption, a location of customer consumption, a time to provide additional inventory (including, for example, time stamps of discrete events of this process), etc.

System 100 may further include resource demand interface 130 that may provide an interface to, for example, customer ordering systems, resource demand monitoring systems, etc. (not shown). Resource demand interface 130 may receive information regarding requests for resources, such as customer orders for finished goods, subassemblies, raw material, requests for human resources including human labor, that may be measured in time, skill, and/or quantity, requests for data and/or computation, requests for automation initiation and/or outcomes, requests for workflow initiation and/or outcomes, and requests for process initiation and/or outcomes. Resource demand interface 130 may interface with discrete systems, request from message buses, requests via application programming interfaces, etc.

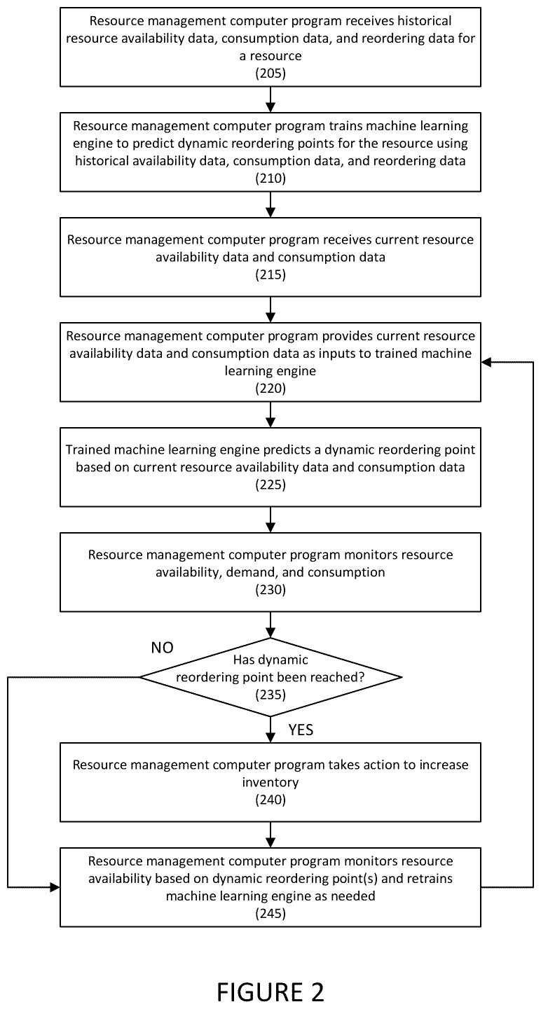

Referring to FIG. 2, a method for machine learning-based identification of dynamic resource reordering points is provided according to an embodiment.

In step 205, a resource management computer program may receive resource availability data including, for example, historical availability data, consumption data, time stamps of relevant events, times to replenish data, reordering data for a resource from one or more databases or systems, such as resource information databases, resource cost data, etc. In one embodiment, the resource management computer program may also receive external data, such as weather data, local and global environmental data, telemetry of machinery and systems, timing within a lifecycle or lifecycle-to-lifecycle transition, availability of labor, availability of transportation, impact on border customs, availability of raw material, geopolitical data, market data, availability or speed of computer-to-computer information flow (e.g., network traffic), computational capacity, connection capacity and data, etc., some or all of which may impact supply and/or demand for the resource.

In step 210, the resource management computer program may train a machine learning engine to predict dynamic resource reordering points for the resource using the historical availability data, consumption data, cost data, and/or reordering data. In one embodiment, the resource management computer program may use supervised learning to train the machine learning engine. In another embodiment, the machine learning engine may train a neural network.

In one embodiment, the machine learning engine may be trained using a plurality of different timescales. For example, the machine learning engine may be trained for a one-week time period, a one-month time period, and a six-month time period. Each may result in a different model, and embodiments may select the most accurate model based on the historical data.

In step 215, the resource management computer program may receive resource information, such as current resource availability data, current resource demand data, current resource reordering data, time stamps of relevant events, time to replenish resources, current resource consumption data for a resource, resource cost data, etc. The resource information may be provided from an inventory system that may manage a pool of resources, from a resource monitoring system, etc. The data may be sufficient to permit calculation of one or more statistics, such as standard deviation and patterns of data distribution.

In one embodiment, supply-related data from external sources that may impact the supply and/or demand of the resource (e.g., weather data, geopolitical data, market data, additional resource availability data, raw material availability data, etc.) may also be received.

In step 220, the resource management computer program may provide current resource availability data, current resource demand data, and current resource consumption data as inputs to a machine learning engine that has been trained to predict one or more dynamic resource reordering points for the resource. In one embodiment, the resource management computer program may also provide the external data to the machine learning engine.

In step 225, the trained machine learning engine may predict one or more dynamic resource reordering points based on the data received. The one or more dynamic resource reordering points may be based on a time (e.g., a date, a time of day, a season, etc.), the occurrence of a demand event (e.g., when inventory for the resource falls below a certain threshold, when a certain resource demand velocity is reached, combination thereof, etc.), etc.

In one embodiment, multiple dynamic resource points may be predicted, and the most constraining dynamic resource may be selected. For example, if a computing resource that includes CPU, memory, and storage is needed, dynamic resource points for CPU, memory, and storage may be individually predicted, and the most constraining is selected.

In step 230, the resource management computer program may monitor the resource availability, demand, consumption, and may further monitor the external data for any changes that may impact resource availability. In one embodiment, the rate of change of any of these metrics may be calculated, or a behavior change and/or behavior anomalies may be detected to predict when a re-order point will be reached before the reordering point is reached.

In step 235, if a threshold for a dynamic resource reordering point is met, in step 240, the resource management computer program may take an appropriate action, such as increasing the amount of available inventory by, for example, ordering resources from a supplier, making resources available, opening blocked access to resources, satisfying one or more requirements for resources, initiating a workflow, initiating a process, initiating automation, posting an event for consumption, placing a request in a queue, hiring or allocating human resources, reallocating committed or uncommitted resources, etc. For example, the resource management computer program may instruct an upstream system to increase the available inventory of the resource.

In one embodiment, once an action is taken by the system, the action may be logged and tracked across different statuses (e.g., initial, in progress, failed, completed). The resource management computer program may continuously monitor the reorder points and can perform a self-recover on an action that is already tracked, and close it as no longer needed. This may occur, for example, if the action has not reached a “point of no return.”

A request for additional resources may be made available to a supplier community that permits competitive bid, first-response acknowledgement, round-robin assignment, ledger-based acknowledgement (e.g., block chain), or other assignment-based means of acknowledging and satisfying such request for resources from a single consumer to multiple suppliers.

If step 245, the resource management computer program may monitor resource availability based on the dynamic resource reordering point(s) and may retrain the machine learning engine based on the monitoring.

The process may repeat as is necessary.

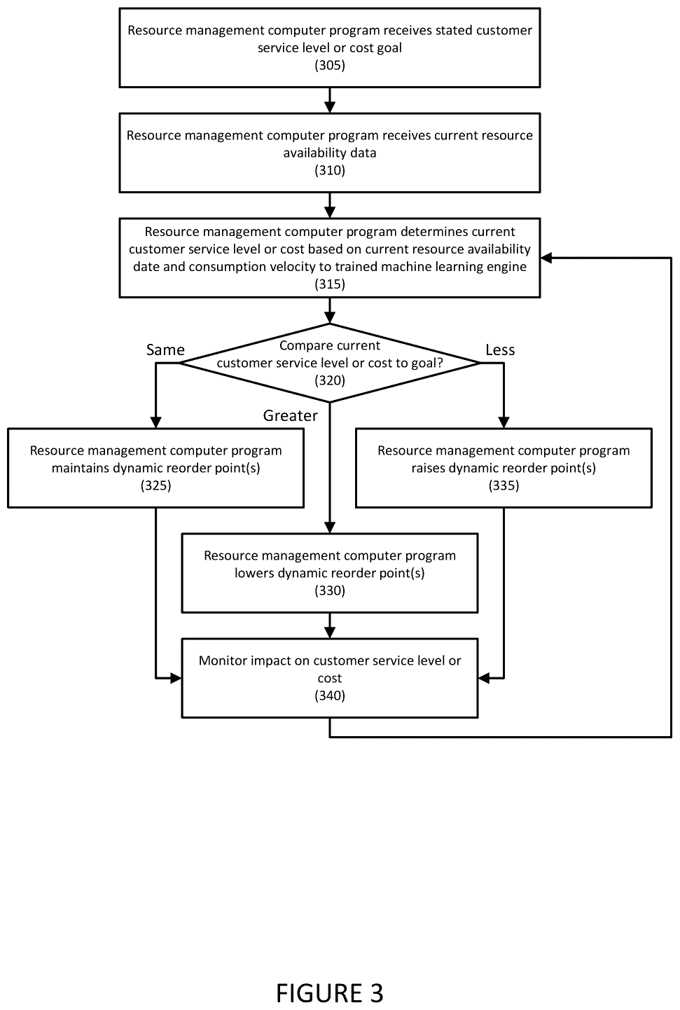

Referring to FIG. 3, a method for machine learning-based identification of dynamic resource reordering points is provided according to another embodiment.

In step 305, a resource management computer program may receive a stated goal for a customer service level or a cost of maintaining an inventory of resources. For example, the customer service level may be based on any suitable metric, such as time from resource request to resource availability (e.g., time between ordering and shipping), the percentage of time that a customer's request can be satisfied no matter the size of the request, etc.

The cost of maintaining the inventory of resources may be a daily cost, a weekly cost, a monthly cost, etc. The cost may be in dollars, time, man-hours, energy, opportunity costs, or any other suitable quantity.

In step 310, the resource management computer program may receive current resource availability data, such as current resource inventory, current demand data, current resource request velocity (e.g., the speed at which new requests for the resource are received), and current reordering point(s).

In step 315, given the received data, the resource management computer program may determine a current customer service level for the resource or a current cost of maintaining an inventory of resources. For example, the resource management computer program may calculate the current customer service level for one or more future resource requests based on the current inventory and the reordering points. The customer service level may be based on, for example, an amount of time (e.g., seconds, minutes, hours, days, etc.) for a requested resource to be made available or delivered to the customer. The cost may be provided by manual entry, from external systems or databases (e.g., accounting databases, human resources databases, etc.), or any other suitable source.

In embodiments, the resource management computer program may analyze past behavior or one or more customer and/or one or more suppliers for a user-specified or machine learning-discerned period of time to analyze optimum investment versus customer service level. Embodiments may identify one or more inflection points at which the cost of the inventory of resources increases at an increasing rate versus the customer service level (i.e., the knee or elbow in the curve) and may define the re-order point(s) for this inflection point.

Embodiments may also identify the incremental cost of increasing the customer service level from this inflection point and/or the degradation in the customer service level for a desired cost savings from the inflection point. This may be done, for example, by simulation. The cost may be associated with having additional inventory on hand, the degradation may be associated with any delay in providing the resource to the consumer. In one embodiment, this may be achieved by simulation using historical production and demand data.

In step 320, the resource management computer program may compare the current customer service level to the stated customer service level goal, or may compare the current cost to the cost goal. If they match, in step 325, the dynamic resource reordering point(s) may be maintained.

If the current customer service level is greater than the customer level goal, or the current cost is greater than the cost goal, meaning that there are too many resources in inventory, in step 330, the resource management computer program may lower the dynamic resource reordering point(s) to slow the reordering of resources. In one embodiment, the resource management computer program may seek to return a number of resources to the supplier in order to cause the current customer service level or cost to be closer to the customer service level goal.

If the current customer service level is less than the customer service level goal, or the current cost is less than the cost goal, meaning that there is insufficient inventory, in step 335, the resource management computer program may raise the dynamic resource reordering point(s) to order resources sooner than the dynamic reorder point. For example, the resource management computer program may instruct one or more downstream resources to request or order resources from a supplier.

In step 340, the resource management computer program may monitor the impact of the change or no change on the dynamic resource reordering point(s) and may provide the current customer service level and/or cost as feedback to the trained machine learning engine in step 315. For example, the feedback may be used to update the weights for the machine learning engine.

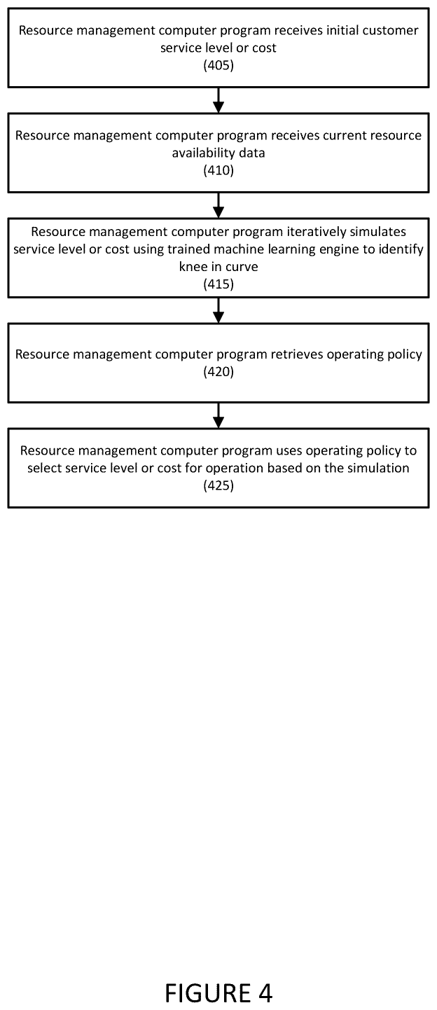

Referring to FIG. 4, a method for determining an optimal reordering point using simulation according to an embodiment.

In step 405, a resource management computer program may receive an initial customer service level and an initial cost of maintaining resources in inventory.

In step 410, the resource management computer program may receive historical resource data. For example, the historical resource data may be an actual quantity of resources that are consumed, or it may be a hypothetical historical model.

In step 415, the resource management computer program may perform iterative simulations using a trained machine learning engine. For example, the resource management computer program may start with a first variable (e.g., the initial customer service level), and may calculate the second variable (e.g., a current cost)—or vice-versa—using the trained machine learning engine. The process may repeat until then the slope of change in the first variable divided by the change in the second variable is compared to the set of slopes (or derivatives) over the simulated iterations to identify the knee in the curve.

In one embodiment, the resource management computer program may output the first variable (e.g., the customer service level) and the second variable (e.g., the cost) for each iteration.

In step 420, the resource management computer program may identify an operating policy, such as operating at the knee in the curve (the optimized customer service level and cost), operating “above” the knee in the curve (i.e., higher cost for the sake of a no-lower-than service level policy), or operating “below” the knee in the curve (i.e., lower service level for the sake of a no-higher-than maximum cost policy). In one embodiment, the operating policy may be set by the organization. In another embodiment, it may be derived by an optimizing algorithm.

In step 425, the resource management computer program may use the operating policy to select an operating cost based on the second variable in the simulation, such as operating at, above, or below the knee in the curve. In one embodiment, the resource management computer program may use the operating policy as the stated cost goal for the method of FIG. 3 and may control systems to implement the stated cost goal. In other embodiment, the resource management computer program may use the operating cost policy as the stated service level goal for the method of FIG. 3 and may control systems to implement the stated cost service level goal.

Although several embodiments have been disclosed, the embodiments are not exclusive, and features disclosed in one embodiment may be used with other embodiments.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for machine learning-based identification of dynamic resource reordering points, comprising:
receiving, by a resource management computer program executed on an electronic device, historical resource availability data, historical resource consumption data, and historical resource reordering data for a resource;
training, by the resource management computer program, a machine learning engine to predict dynamic resource reordering points for the resource using the historical resource availability data, the historical resource consumption data, and the historical resource reordering data;
receiving, by the resource management computer program, current resource availability data, current resource demand data, and current resource reordering data for the resource;
predicting, by the resource management computer program and using the machine learning engine, a dynamic resource reordering point for the resource based on the current resource availability data, the current resource demand data, and/or the current resource reordering data; and
requesting, by the resource management computer program, additional resources in response to threshold for the dynamic resource reordering point being met.

2. The method of claim 1, wherein the resource comprises a physical good or a service.

3. The method of claim 1, wherein the resource comprises a computer resource.

4. The method of claim 3, wherein the current resource availability data is received from the computer resource.

5. The method of claim 1, wherein the resource comprises a human resource.

6. The method of claim 1, wherein the resource management computer program trains a plurality of machine learning engines using different timescales and selects the machine learning engine that is most constraining.

7. The method of claim 1, further comprising:
receiving, by the resource management computer program, external data, wherein the external data impacts supply or demand for the resource.

8. The method of claim 1, further comprising:
receiving, by the resource management computer program, supply-related data for the resource.

9. The method of claim 1, wherein the current resource availability data is received as telemetry of machinery.

10. The method of claim 1, wherein the resource management computer program trains the machine learning engine using supervised learning or trains a neural network.

11. The method of claim 1, further comprising:
monitoring, by the resource management computer program, the current resource availability data, current resource demand data, and current resource reordering data for a change that changes the dynamic resource reordering point; and
predicting, by the resource management computer program and using the machine learning engine, an updated dynamic resource reordering point for the resource based on the current resource availability data, the current resource demand data, and/or the current resource reordering data.

12. The method of claim 1, wherein the dynamic resource reordering point comprises a data, a time of day, a minimum availability threshold, a demand velocity, and/or occurrence of a demand event.

13. A method for machine learning-based identification of dynamic resource reordering points, comprising:
receiving, by a resource management computer program executed by an electronic device, a stated customer service level or cost goal for a resource;
receiving, by the resource management computer program, current resource availability data for the resource;
determining, by the resource management computer program, a current customer service level or cost for the resource;
comparing, by the resource management computer program, the current customer service level to the customer service level goal, or the current cost to the cost goal;
executing, by the resource management computer program, and action in response to the comparison;
monitoring, by the resource management computer program, an impact of the execution; and
retraining, by the resource management computer program, a trained dynamic resource reordering point machine learning engine based on the monitoring.

14. The method of claim 13, wherein the resource comprises a physical good or a service.

15. The method of claim 13, wherein the resource comprises a computer resource.

16. The method of claim 13, wherein the resource comprises a human resource.

17. The method of claim 13, wherein the customer service level goal and the current customer service level are based on a time to make the resource available.

18. The method of claim 13, wherein the action comprises raising a dynamic resource reordering point in response to the current customer service level being below the customer service level goal.

19. The method of claim 13, wherein the action comprises lowering a dynamic resource reordering point in response to the current customer service level being above the customer service level goal.

20. The method of claim 13, wherein the customer service level goal or the cost goal is based on a simulation.
